(19) United States
(12) Patent Application Publication
(10) Pub. No.: US 2004/0144818 A1
(43) Pub. Date: Jul. 29, 2004

(54) Archery bow rack

(76) Inventor: Frank J. Marhefka, Auburn, MA (US)

Correspondence Address: Andover-IP-Law, Suite 300, 44 Park Street, Andover, MA, 01810, US

(21) Appl. No.: 10/758,578

(22) Filed: Jan. 15, 2004

Related U.S. Application Data
(60) Provisional application No. 60/440,564, filed on Jan. 16, 2003.

(51) Int. Cl. B60R 7/00; B60R 9/00; B60R 11/00

(52) U.S. Cl. 224/275; 224/539

(57) ABSTRACT

A portable archery bow holder for supporting one or more archery bows in a generally horizontal position in the interior of a motor vehicle is disclosed. A tubular, lightweight frame structure, for example of aluminum construction, has a plurality of leg and horizontal support adjustments to accommodate the verity of make and model interior vehicle dimensions, i.e., cargo area of an SUV, back seat of a car, jump seat of a pick-up truck, and limb supports to hold one or more archery bows. The limb supports of the rack or bow holder are preferably padded so as to protect the bow limbs from any damage while in the bow rack and while the vehicle is in transit. The rack is lightweight and not permanently attached to the vehicle. It requires no structural alterations to the interior of the vehicle.

### BACKGROUND OF THE INVENTION

This invention relates generally to portable, removable archery racks designed for the interior of motor vehicles. Various methods have been used over the years to transport archery bows to and from locations for shooting archery bows. Archery bow cases have long been used for transporting archery bows. Both hard shell and soft cases are well known. Archery bow cases provide protection wherever the archery bow is being transported.

Archery bows have evolved into very sophisticated and expensive pieces of equipment, and damage to a bow represents a significant economic loss to the archer. In addition, misalignment of the sight of a bow by bumping or mishandling can ruin a hunting trip or field tournament. Therefore, it is highly desirable to securely immobilize the bow within the vehicle while driving. One major problem with respect to transporting archery bows, particularly in hard cases, is that they consume a large amount of interior compartment space.

This invention is directed to an apparatus for transporting one or more bows to and from a hunting or tournament site inside a motor vehicle while still leaving room for passengers. The apparatus of this invention is not permanently attached to the motor vehicle. The equipment is secure in the cargo area or back seat of a vehicle without being cased, and with the bow or bows being transported in a fully functional state.

### BRIEF DESCRIPTION OF THE DRAWINGS

FIG. 1 is a 3D view of a portable archery bow rack in accordance with this invention.

FIG. 2 is a side view of the archery bow rack of FIG. 1.

FIG. 3 is a top view of the archery bow rack of FIG. 1.

FIG. 4 is a front view of the archery bow rack of FIG. 1.

### DETAILED DESCRIPTION OF PREFERRED EMBODIMENTS

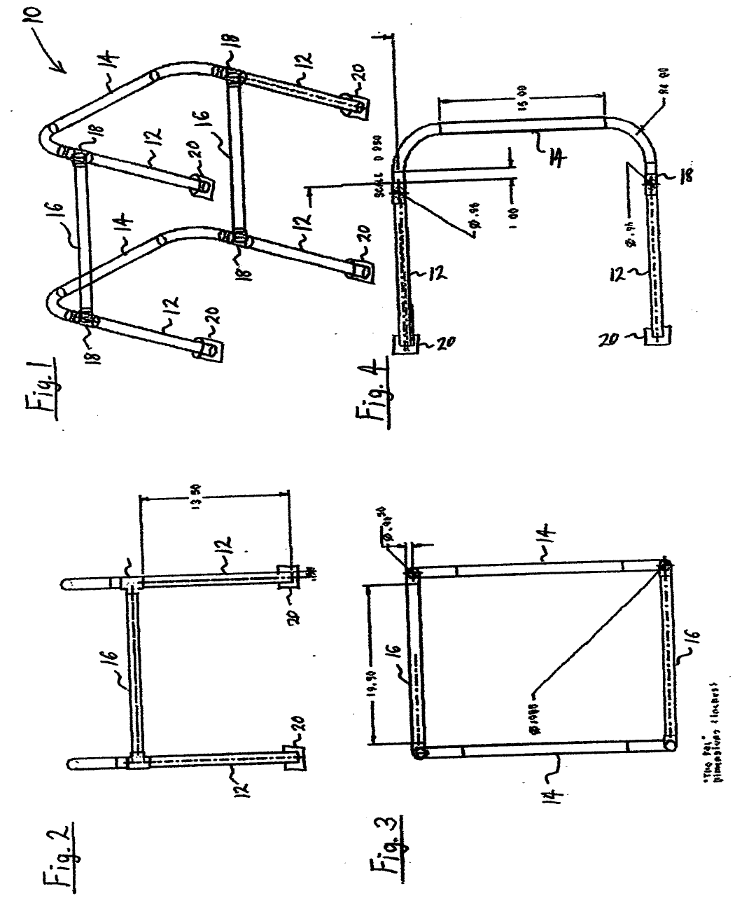

FIG. 1 is a 3D or perspective drawing schematically depicting an archery bow rack 10 according to this invention shown with identical complete front and back frame portions and two identical cross members. The front and back frame portions of the rack consist of five parts each: two leg members 12, each having a foot portion for resting on a surface, two three-armed joints or T-fittings 18, and a horizontal or cross frame member 14. The leg members 12 and member 14 are joined at the T-fittings 18. In a preferred embodiment of this invention, each foot portion of a leg member 12 has a rubber tip or cap 20 to prevent damage to the surface which supports the leg members. In a further embodiment of this invention, leg members 12 can be constructed to be adjustable to different heights as needed, for example by forming leg members 12 from telescoping tubes or by similar means. In another embodiment, horizontal or cross frame members 14 can also be constructed to be adjustable to different lengths as needed, for example by forming members 14 from telescoping tubes or by similar means. In yet another embodiment, frame members 14 may be covered along all, or at least a portion, of each member 14 with foam rubber tubing or comparable covering.

The front and back frame portions, as described above, are connected to one another by horizontal support members 16, which are joined to the front and back frame portions at T-fittings 18. Horizontal support members 16 are used to support and transport one or more archery bows in accordance with this invention. In a preferred embodiment, members 16 are substantially completely covered with a special high-density, slightly sticky sponge foam tubing to cushion the bows, and to prevent movement or damage during transport.

In one representative embodiment of this invention, leg members 12 each comprise a 13.5″ length of 1″ OD extruded drawn seamless aluminum tubing. T-fitting 18 is a brushed aluminum 1″ ID tee fitting, or, alternatively, in another preferred embodiment, a tubing connector or saddle-T made, for example, of nylon or other plastic, may be advantageously used in place of T-fitting 18. Each member 14 is a 23″ length of 1″ OD extruded drawn seamless aluminum tubing with a 4″ quarter round bend on each end of the tubing. Each cap element 20 is a 1″ ID rubber tip for the foot portion of each leg member of the rack. Each member 14 is covered with foam rubber tubing. Each support member 16 is a 19.5″ length of 1″ OD extruded drawn seamless aluminum tubing covered with a 19.5″ length of closed cell CPE/EPDM blend sponge foam tubing with a 30 lbs./ft.³ density measuring 0.940″ ID with a 0.25″ wall.

FIG. 2 shows the side view of the archery bow rack of FIG. 1 depicting the front and back frame portions and one cross member 16.

FIG. 3 is a top view of the archery bow rack of FIG. 1 depicting identical complete front and back frame portions and two identical cross members 16.

FIG. 4 is a front view of the archery bow rack of FIG. 1 depicting the front frame portion.

It will be apparent to those skilled in the art that changes and modifications may be made in the above-described apparatus for an archery bow rack without departing from the spirit and scope of the invention herein, and it is intended that all matter contained in the above description shall be interpreted in an illustrative and not a limiting sense.

Having described the invention, what is claimed is:

1. A portable archery bow holder for the interior of a vehicle, said bow holder comprising a tubular frame assembly including leg members, each having a foot portion, cross frame members, and at least two spaced horizontal support members to support the limbs of an archery bow in a generally horizontal position.

2. A portable archery bow holder for the interior of a vehicle according to claim 1, wherein said bow holder further comprises a plurality of leg height adjustment devices as part of said leg members to conform to the verity of interior floor and seat configurations between different vehicle makes and models.

3. A portable archery bow holder for the interior of a vehicle according to claim 1, wherein said bow holder further comprises a plurality of length adjustment devices as part of said cross frame members to conform to the verity of interior floor and seat configurations between different vehicle makes and models.

4. A portable archery bow holder for the interior of a vehicle according to claim 1, further wherein the horizontal support members of the bow holder are covered in a protective foam material to prevent damage to the limbs of the bows in the holder while in transit.

5. A portable archery bow holder for the interior of a vehicle according to claim 1, further wherein said foot portions of said leg members of the bow holder are covered with end caps to protect the interior surfaces of the vehicle.

6. A portable archery bow holder for the interior of a vehicle according to claim 2, wherein said leg height adjustment devices comprise telescoping leg members.

7. A portable archery bow holder for the interior of a vehicle according to claim 3, wherein said length adjustment devices comprise telescoping cross frame members.
